(19) United States
(12) Patent Application Publication
(10) Pub. No.: US 2006/0048367 A1
(43) Pub. Date: Mar. 9, 2006

(54) System and method of manufacturing tip device

(75) Inventors: Yasushi Ishihama, Tsukuba-shi (JP); Takashi Usui, Tokyo (JP)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignees: Eisai Co., Ltd., Tokyo (JP); Nikkyo Technos Co., Ltd., Tokyo (JP)

(21) Appl. No.: 11/212,174

(22) Filed: Aug. 26, 2005

(30) Foreign Application Priority Data
Aug. 27, 2004 (JP) 2004-249264
Aug. 25, 2005 (JP) 2005-243661

(51) Int. Cl. B23P 11/00

(52) U.S. Cl. 29/432; 29/34 R

(57) ABSTRACT

A filter filling apparatus serving as a system for manufacturing a tip device according to the present invention comprises, for example, on a base inside a casing, a sheet holder with a sheet-like filter carried thereon and a tip rack where a plurality of tips are held in a matrix-like configuration. Furthermore, a small-diameter filter punching-discharging mechanism having a plurality of small-diameter pipes disposed in a row and movable in the vertical direction and a filter push-in mechanism having a plurality of small-diameter rods disposed in a row and movable in the vertical direction are provided above the sheet holder and the tip rack. A cylinder connected to a nitrogen gas supply unit is connected via piping to the small-diameter pipes.

### BACKGROUND

The present invention relates to a system for manufacturing a tip device and a method for the same.

Proteome analysis has attracted much attention as an important research of a post-genome era using biological samples. In proteome analysis, comprehensive analysis of cellular proteins in living organisms is conducted, and in recent years protein separation by electrophoresis and protein profiling by mass spectrometry have been frequently conducted.

Samples for mass spectrometry in proteome analysis are, for example, solutions comprising digested peptide fragments that are obtained by implementing protein enzymic digestion in a gel and then recovering by using a solution reagent or the like. In this case, if the recovered solution is directly used for mass spectrometry, small impurities or inorganic salts containing in the solution might adversely affect the sensitivity or the accuracy of the analysis, and the sufficient reproducibility in the results sometimes cannot be obtained. Furthermore, when the concentration of biological molecules in the recovered sample is not sufficiently high, mass spectrometry is sometimes difficult to conduct when the sensitivity of the instrument employed is not so high.

In order to solve those problems the recovered solution sample is usually subjected to a pretreatment step such as purification treatment or concentration treatment serving to separate and remove the impurities or inorganic salts. Furthermore, in many cases, the pretreatment involving purification or concentration of samples comprising peptides, proteins, oligonucleotides, etc., is necessary not only in mass spectrometry in proteome analysis, but also, for example, in high performance liquid chromatography, capillary electrophoresis, and other analytical methods.

Examples of such pretreatment procedures include a variety of treatments such as gel filtration, but they generally require tedious operations. Accordingly there is a strong need for a simple pretreatment method that can be implemented within a short time. A method using a solid-phase extraction cartridge (trademark: Empore™ Disk Cartridge) in which a disk having a filler of silicagel or the like fixed with PTFE fibers is accommodated in a tubular member, as described in the homepage Sumitomo 3M Co. (searched on Aug. 10, 2004), internet <URL: http://www.mmm.co.jp/fibrous/empore/ctrg/index.html> is an example of such a simple pretreatment method. However, such solid-phase extraction cartridges are unsuitable for analyzing microscale samples.

On the other hand, a pipette tip (trademark: ZipTip™ pipette tip) having a distal end section thereof filled with a chromatographic resin, as described in the homepage of Nippon Millipore Co., Ltd. (searched on Aug. 10, 2004), internet <URL: http://www.millipore.com/catalogue.nsf/docs/C5737?open&lang=ja> is known as a tip-type pretreatment apparatus suitable for analyzing microscale samples. However, in this pipette tip, the target substance such as a peptide contained in the solution is trapped during aspirating and dispensing the sample solution by using a pipetter, and the inside of the pipette tip is loosely filled with the chromatographic resin. For those reasons, the recovery ratio of the target substance is insufficient (Steward II, Thomson T., and Figeys D., Rapid Commun. Mass Spectrum. 2001; 15(24):2456-65). Furthermore, because the sample solution is aspirated from below the chromatographic resin and dispensed therebelow, when solids (for example, gel pieces and the like) are contaminated to the solution, they cannot be removed.

Accordingly, in order to resolve the above-described two problems, the inventors have developed a tip device (trademark; StageTip) described in Rappsilber J., Ishihama Y., and Mann M., Anal. Chem. 2003 Feb. 1; 75(3):663-70). This tip device comprises a column bed having a length and a diameter each less than 1 mm, in which resin beads for reversed phase extraction are embedded in and supported by a Teflon® mesh, and is suitable for ultramicroanalysis. Furthermore, because the filling ratio of the resin is increased and the sample solution is pumped in from above the column bed and dispensed to the zone below the column bed, the recovery of the target substance from the sample solution is very high.

### SUMMARY

However, in the tip device described in Rappsilber J., Ishihama Y., and Mann M., Anal. Chem. 2003 Feb. 1;75(3):663-70, the above-described small column bed is loaded into a container having a taper formed at the distal end section such as pipette tip, and presently the manufacturing process including this loading step is conducted manually. Therefore, a limitation is placed on increase in manufacturing efficiency and a large number of tip devices are difficult to fabricate within a short time. Furthermore, the loading state varies between the devices and uniform product quality is difficult to guarantee. Moreover, the experimenters often fabricate the tip devices manually at the analysis sites and in such a case the operation efficiency of the entire test tends to degrade.

The present invention has been made in view of the above circumstances and has for its object to provide a manufacturing system and method making it possible to manufacture easily and within a short time a tip device of stable quality that is suitable for pretreatment of solutions or liquid samples.

In order to resolve the above-described problems, the present invention provides a system for manufacturing a tip device for pretreating solutions or liquid samples, this system comprising a gas supply section for supplying a gas into a tip via a pipe having a substantially tubular shape, so that a pretreatment member held inside the pipe is discharged to the outside of the pipe. Furthermore, the state in which the pretreatment member is held inside the pipe is not particularly limiting, and the pretreatment member may be held so as to be pushed to the outside of the pipe by the supply of gas into the pipe. More specifically, for example, a state can be employed in which the pretreatment member is attached inside the pipe loosely and to the appropriate density.

In the system for manufacturing tip devices of such a configuration, supplying gas into the tip through a pipe having the pretreatment member held inside thereof makes it possible to discharge the pretreatment member from the pipe and load it into the tip rapidly and reliably. A tip device having the pretreatment member attached inside thereof is thus manufactured.

Furthermore, it is preferred that the system comprises: (1) a sheet holding section where a sheet member including the pretreatment member is placed, (2) a tip holding unit which holds the tip, (3) a sheet punching unit comprising the pipe having a substantially tubular shape and a first drive unit that drives the pipe so that one end of the pipe punches part of the sheet member and so that the pipe that holds part of the punched sheet member is inserted into the tip, wherein (4) the gas supply section is connected to the other end of the pipe and supplies a gas into the tip so that part of the sheet member held inside the pipe is discharged to the outside of the pipe.

With such a configuration, part of the sheet member placed on the sheet holding section is punched by one end of the pipe driven by the first drive unit. Part of the punched sheet member is separated so as to be cut off from the sheet member by the peripheral wall of one end of the pipe having a substantially tubular shape and is so held as to be fit inside one end side of the pipe. This pipe is driven by the first drive unit and portion at one end side thereof where part of the sheet member is held is inserted into a hollow tip held in the tip holding unit.

Further, if gas such as air, nitrogen or other inactive gas is supplied into the pipe from a gas intake unit connected to the other end of the pipe, part of the sheet member that was held so as to fit into one end side of the pipe is blown out by the gas pressure. The tip is usually formed to have a hollow shape tapered toward the distal end section thereof (for example, inverted conical or tapered shape), and the part of the sheet member that was blown out moves toward the distal end section, abuts against the distal end section, and stops. Part of the sheet member is thus loaded into the tip.

At this time, part of the sheet member can be firmly loaded and fixed so as to be attached to the distal end section of the tip by the blowing pressure of the gas, but if the gas is further continuously supplied from the air supply section, then the gas will be ejected through the pipe from one end thereof toward the distal end of the tip, and part of the sheet member can be loaded so as to be strongly fixed by the distal end section to the tip under the effect of gas pressure thereof. A tip device having part of the sheet member fixedly held in the distal end section thereof is thus manufactured.

Furthermore, the system preferably comprises a sheet push-in unit comprising a rod having a substantially tubular or substantially columnar shape and a second drive unit which drives the rod so that the rod is inserted into the tip and so that the rod pushes in the part of the sheet member that was discharged into the tip.

With such a configuration, the second drive unit is operated, the rod of the push-in unit is inserted into the tip into which part of the sheet member was discharged, this rod is caused to move toward the distal end side of the tip, and part of the sheet member is reliably pushed in. Therefore, part of the sheet member can be more firmly embedded in the distal end section of the tip. In this case, after part of the sheet member has been discharged into the tip, gas supply from the gas supply section may be continued, but this is not always necessary.

No specific limitation is placed on the shape of the pipe of the sheet punching unit, provided that it is substantially tubular. Furthermore, no specific limitation is placed on the tip shape, provided that it is hollow. However, it is preferred that one end section of the pipe be cylindrical and that the distal end section of the tip be in the form of inverted cone. In this case, part of the sheet member that was punched through has a round shape and can be easily and tightly fitted, without a gap, into the distal end section of the tip in the form of inverted cone.

It is further preferred that in the tip holding unit, a plurality of the tips be arranged side by side, and it is still further preferred that the sheet punching unit comprise a plurality of said pipes. Moreover, it is also advantageous if the sheet push-in unit comprises a plurality of said rods.

If a plurality of tips is thus used, a plurality of tip devices in which part of the sheet member is fixedly held in the distal end section can be continuously manufactured at the same time, the number of the tip devices corresponding to the number of pipes in the sheet punching unit.

Here, a configuration in which the tips and pipes are arranged unidirectionally in a row or, when the number thereof is even larger, a configuration in which at least tips or pipes are arranged in the form of a matrix (row-column configuration) represent specific examples of arrangements using a large number of tips and/or pipes.

More specifically, an adsorption member for adsorbing target components contained in a solution or liquid sample can be advantageously used as the pretreatment member.

Furthermore, a large number of sheet punching units can be advantageously provided. For example, if a twin system of sheet punching units (two units) is used, then operating both systems at the same time or operating them alternately so that one sheet punching unit executes punching of the sheet member, while part of the sheet member that was cut out and held by another sheet punching unit fills the inside of the pipe, makes it possible to manufacture tip devices within a short time. Thus, the tips can be rapidly filled with the sheet member and the production efficiency is greatly increased. Furthermore, in this case, a plurality of sheet push-in units may be also provided.

Furthermore, it is preferred that the sheet punching unit comprise a sheet fixing unit provided so that the sheet member is fixed when part of the sheet member is punched by one end of the pipe. In this case, because the sheet member is fixed and stabilized by the sheet fixing unit, problems associated with the displacement of the sheet member that can occur when the sheet member is punched with the pipe, or impossibility of reliable punching of the sheet member resulting from such a displacement can be resolved and the production yield can be increased.

It is further preferred that the sheet fixing unit fix the circumference of the pipe in the sheet member when one end of the pipe abuts against the sheet member. In this case, “the circumference” is preferably the zone in the sheet member which is surrounded by one end of the pipe, that is, the region in immediate proximity to the portion of the sheet member that will be punched out with the pipe. It is further preferred, that the sheet fixing unit applies pressure and fixes, for example so as to cover, a very large surface area around the pipe in the sheet member when the sheet member and the pipe abut against each other.

Based on the inventor's knowledge, it was confirmed that when the circumference of the zone that is to be punched with the pipe is fixed by applying a pressure over a wide area, the shape of the outer periphery of the part of the sheet member that was punched out becomes smoother and the dimensional accuracy increases greatly by comparison with the case in which the sheet member is fixed by local pressure application (for example, by applying pressure in several places, e.g., in four corners of the sheet member). This is especially useful when a comparatively thin sheet member with a thickness of less than several millimeters is punched. As a result, the discharge of the sheet member from the pipe and the attachment thereof to the tip can be conducted smoother and the production efficiency and product yield are further increased. Furthermore, it was confirmed that more reliable punching of the sheet member is possible and that the product yield can be further increased.

More specifically, it is especially preferred that the sheet fixing unit has a plate-like shape, has an opening through which the pipe is inserted, be provided on the circumference of the pipe so that the pipe can be guided through the opening, and be impelled toward one end of the pipe along the drive direction of the pipe after being abutted against the sheet member. In this case, the pipe is driven so as to be guided inside the opening of the plate-like sheet fixing member, and when the pipe is abutted against the sheet member, the sheet fixing unit is impelled toward one end of the pipe, that is, toward the sheet member. As a result, because the sheet fixing unit can come into contact with the sheet member so as apply pressure to almost the entire area (almost the entire area except the portion where it abuts against the pipe) of the sheet member, the sheet member can be simply and strongly fixed.

No specific limitation is placed on means for “impelling” the sheet fixing unit. For example, the sheet fixing unit may be impelled under gravity or by a combined weight of the sheet fixing member and members connected thereto. Furthermore, a force may be also applied to the sheet fixing member with means other than the sheet fixing member.

Furthermore, it is even more preferred that the gas supply unit be connected to the other end of the pipe and that it have a pressure adjustment unit for adjusting the gas pressure. In this case, the pressure of the gas at the time of discharging the sheet member to the outside of the pipe can be adjusted randomly or as desired, for example, according to the properties of the sheet member or the shape of the tip. Sheet members of various kinds can be loaded under a pressure suitable for various tips. Furthermore, adjusting the gas pressure makes it possible to attach part of the sheet member more reliably to the distal end section of the tip and to fix it more strongly therein by a sufficient blow-out pressure. Therefore, in this case, the filter push-in mechanism becomes unnecessary, and restrictions placed on the arrangement when the above-mentioned multiple sheet punching units are provided can be relaxed, while simplifying the apparatus scale.

Furthermore, it is preferred that the thickness of one end of the pipe is set less (the end is thinner) than the thickness of the body section of the pipe. In this case, the pressure is easily concentrated in the distal end of one end of the pipe and the sheet member can be cut easier and punched more reliably. Furthermore, because the distal end at one end of the pipe is tipped, the outer peripheral shape of part of the sheet member that was punched out becomes smoother and dimensional accuracy is greatly increased.

Alternatively, if the thickness of the pipe decreases gradually in the direction toward this end, the distal end can be tipped even more significantly, as a cutting edge, and this configuration is, therefore, especially preferred.

Furthermore, the sheet holding unit preferably has a smooth surface where the sheet member is placed. The “smooth surface”, as referred to herein, is a surface that has no recesses in the zone to be abutted against the pipe, and a contact is thereby provided between the smooth surface and the sheet member placed thereon.

In this case, it is preferred that the sheet punching unit be so provided that part of the sheet member is punched by the movement of one end of the pipe to the position abutting against the smooth surface of the sheet holding member. Thus, it is preferred that when the sheet member is punched, one end of the pipe moves to a position in which it substantially just comes into contact with the smooth surface of the sheet holding unit and does not penetrate further (that is, deeper into the smooth surface). This measure, in combination with a smooth surface of the sheet holding unit, makes it possible to prevent the indentation of the side of the sheet holding unit with the sheet member and to realize reliable punching when the sheet member is punched. This is especially useful with respect to comparatively thin sheet members with a thickness of several millimeters or less.

The method for manufacturing a tip device according to the present invention is a method that is effectively implemented by using the manufacturing system according to the present invention, that is, a method for manufacturing a tip device for pretreating a solution or a liquid sample, comprising a gas supply step of supplying a gas into a tip through a pipe having a substantially cylindrical shape and holding a pretreatment member inside thereof and discharging the pretreatment member into the tip.

Furthermore, it is preferred that a first step of preparing a sheet member including the pretreatment member and a tip and a second step of punching part of the sheet member with one end of a pipe having a substantially tubular shape and separating the punched-out part of the sheet member from the sheet member, while holding it on one end side of the pipe be provided, wherein a third step of inserting one end of the pipe holding the part of the sheet member into the tip, supplying gas into the pipe from the other end of the pipe, and discharging part of the sheet member into the tip be implemented in the gas supply step.

It is even more preferred that a fourth step of inserting a rod having a substantially tubular or substantially columnar shape into the tip and pushing with the rod the part of said sheet member that was discharged into the tip be implemented. More specifically, it is preferred that an adsorption member for adsorbing a target component contained in the solvent or liquid sample be used as the pretreatment member.

Furthermore, it is preferred that in the second step, the sheet member be fixed when part of the sheet member is punched by one end of the pipe.

Furthermore, it is preferred that in the second step, the circumference of the pipe in the sheet member be fixed when one end of the pipe abuts against the sheet member.

With the system and method for manufacturing a tip device according to the present invention, a tip device with a pretreatment member attached inside thereof is manufactured by supplying gas into the tip through the pipe so as to discharge the pretreatment member held inside the pipe to the outside of the pipe. As a result, the tip device can be manufactured easily and within a short item. Furthermore, because reproducibility of operations of loading the pretreatment member into the tip is high, the quality, reliability and yield of the product can be increased.

### DESCRIPTION OF DRAWINGS

FIG. 1 is a front view illustrating schematically a preferred embodiment of the system for manufacturing a tip device according to the present invention;

FIG. 2 is a cross-sectional view along the II-II line in FIG. 1;

FIG. 3 is a cross-sectional view along the III-III line in FIG. 2;

FIG. 4 is a cross-sectional view along the IV-IV line in FIG. 2;

FIG. 5 is a front view illustrating schematically a preferred embodiment of the tip device manufactured by the system for manufacturing a tip device according to the present invention;

FIG. 6 is a front view illustrating schematically another preferred embodiment of the system for manufacturing a tip device according to the present invention;

FIG. 7 is a front view illustrating a schematic configuration of the filter punching-discharging mechanism 7;

FIG. 8 is a cross-sectional view along the VIII-VIII line in FIG. 7;

FIG. 9 is a cross-sectional view along the IX-IX line in FIG. 8;

FIGS. 10(A) to (C) are cross-sectional views illustrating parts of the small-diameter pipe 71;

FIGS. 11(A) to (C) are cross-sectional views illustrating parts of the small-diameter pipe 71; and

FIGS. 12(A) to (C) are cross-sectional views illustrating parts of the small-diameter pipe 71.

### DETAILED DESCRIPTION

The embodiments of the present invention will be explained in details Hereinafter. The above-described embodiments are merely examples designed to illustrate the present invention, and the present invention should not be construed as being limited to those embodiments. The present invention can be implemented in a variety of modes, without departing from the essence thereof. Furthermore, identical elements will be assigned with identical reference numeral or symbol and redundant explanation thereof will be omitted. Mutual arrangements, e.g., in the up-down and left-right directions, will be based on the mutual arrangement shown in the figures, unless stated otherwise. Dimensional proportions in the figures are not limited to the proportions shown in the figures.

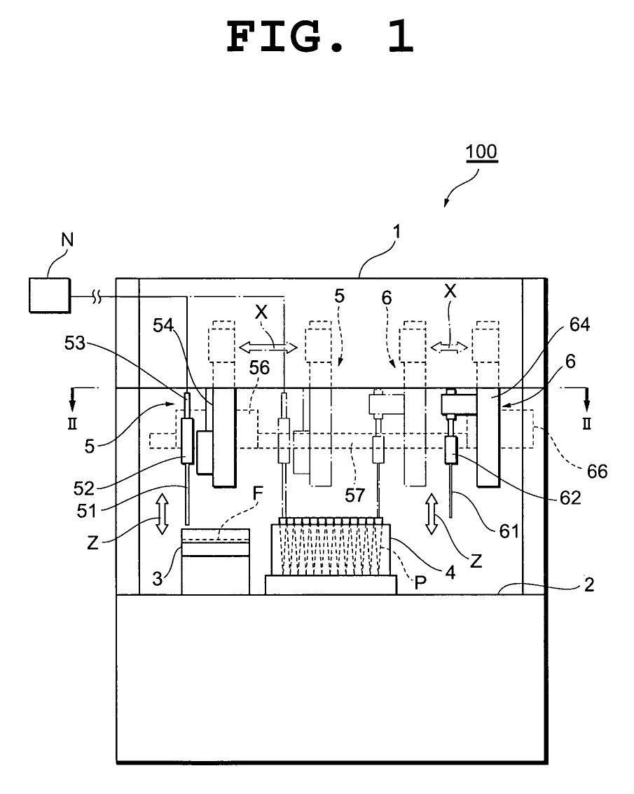

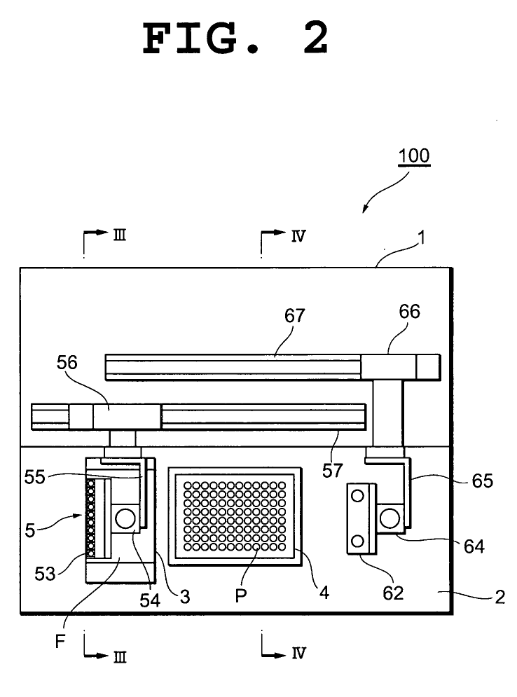

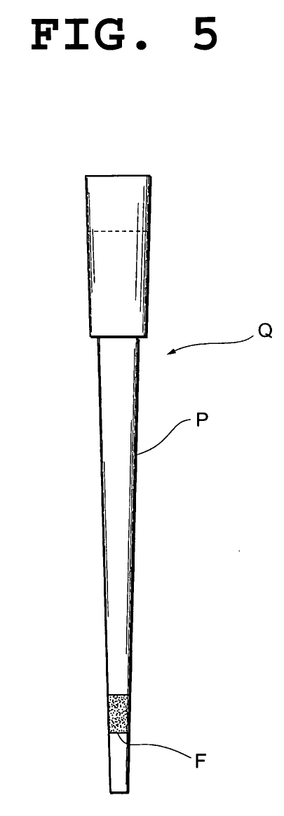

FIG. 1 is a front view illustrating schematically a preferred embodiment of the system for manufacturing a tip device according to the present invention. FIGS. 2 to 4 are a cross-sectional view along the line II-II in FIG. 1, a cross-sectional view along the line III-III in FIG. 2, and a cross-sectional view along the line IV-IV in FIG. 2, respectively. Furthermore, FIG. 5 is a front view illustrating schematically a preferred embodiment of the tip device manufactured by the system for manufacturing a tip device according to the present invention.

A tip filter filling apparatus 100 (system for manufacturing a tip device) is an apparatus for manufacturing a tip device Q shown in FIG. 5 by filling a distal end section of a hollow tip P with a filter F (pretreatment member, sheet member). A tip device of the type described in the aforementioned reference (Rappsilber J., Ihihama Y., and Mann M., Anal. Chem. 2003 Feb. 1;75(3):663-70) is a more specific example of the tip device Q.

The tip filter filling apparatus 100 comprises a sheet holder 3 (sheet holding unit) in which a smooth carrying surface (smooth surface) for carrying a filter F shaped as a sheet is formed on a base 2 inside a casing 1 and a tip rack 4 (tip holding unit) for holding a plurality of tips P arranged in the form of a matrix. Furthermore, a holder in which at least the carrying surface is formed from a resin such as Teflon™ is an example of the sheet holder 3.

In the filter F, for example, an adsorbent or a carrier (adsorption member) such as silica or other reverse phase extraction resin beads are fixed so as to be carried in a resin fiber sheet. No specific limitation is placed on the type of the resin of the fiber sheet. Moreover, the sheet form is not limiting and the filter may be, for example, in the form of a woven or nonwoven fabric. Furthermore, the thickness of the filter F can be, for example, from about 0.1 mm to about several millimeters.

Furthermore, for example, commercial pipette tips for micropipettes can be used without any limitation for the tips P. As for shape thereof, for example, they can have a base section fitted onto a distal end of a pipette (not shown in the figure) and a hollow body tapered as a reversed cone and having an open distal end. Furthermore, no specific limitation is placed on the number of tips P. In the present embodiment, in the example shown in the figure, a total of 96 tips P are arranged as a matrix having 8 rows and 12 columns.

Furthermore, a filter punching-discharging mechanism 5 (sheet punching unit) and a filter push-in mechanism 6 (sheet push-in unit) are provided above, as shown in the figure, the sheet holder 3 and tip rack 4. In the filter punching-discharging mechanism 5, a total of eight straight cylindrical small-diameter pipes 51 arranged in a row in the same direction as the row of tips P are detachably fixed to the holder 52.

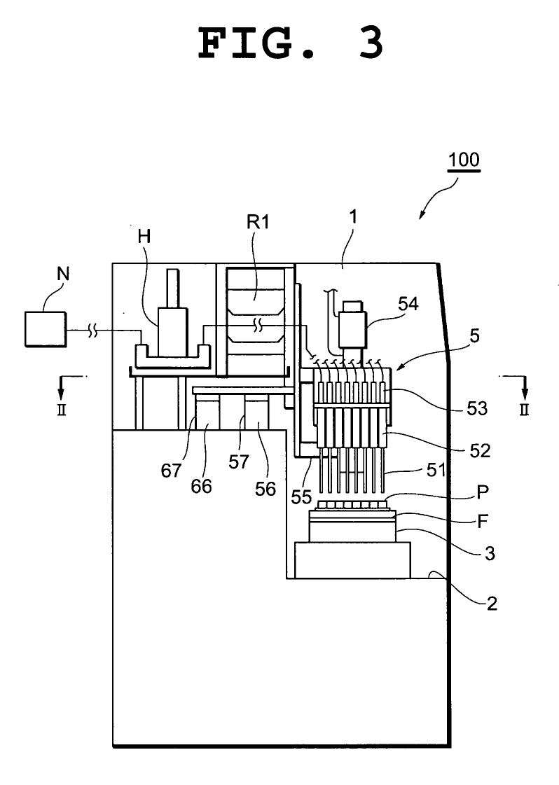

The small-diameter pipes 51 have an inner diameter equal to or somewhat larger than the inner diameter of the distal end section of the tip P. Furthermore, the small-diameter pipes 51 extend in the up-down direction, as shown in the figure, and one end thereof (lower end as shown in the figure) is open. A cylinder 53 connected to a nitrogen gas supply unit N via a piping provided with a valve H (see FIG. 3) is connected to the other ends of the small-diameter pipes 51. The gas supply unit thus comprises the nitrogen gas supply unit N, cylinder 53, and the piping provided with the valve H.

Furthermore, the holder 52 having the small-diameter pipe 51 fixed therein is connected to an actuator 54, and the holder 52 is driven in the up-down direction (direction shown by arrow Z), as shown in the figure. As a result, all the small-diameter pipes 51 are moved up and down at the same time. Furthermore, the actuator 54 is fixed to an actuator 56 with a fixing tool 55, and the actuator 54 is driven in the horizontal direction (direction shown by the arrow X), as shown in the figure, along a rail 57. As a result, the small-diameter pipes 51 move together with the holder 52 at the same time in the horizontal direction, more specifically, the small-diameter pipes 51 move reciprocally within the respective spaces above the sheet holder 3 and tip rack 4. The actuators 54, 56 thus function as a first drive unit.

Furthermore, in the filter push-in mechanism 6, a total of eight straight cylindrical small-diameter rods 61 arranged in a row in the same direction as the row of tips P are detachably fixed to the holder 62. The small-diameter rods 61 have an inner diameter somewhat less than the inner diameter of the distal end section of the tip P. Thus, the small-diameter rod 61 is somewhat thinner than the small-diameter pipe 51. Furthermore, the small-diameter rods 61 extend in the up-down direction, as shown in the figure, the holder 62 to which they are fixed is connected to an actuator 64, and the holder 62 is driven in the up-down direction (direction shown by arrow Z) in the figure. As a result, all the small-diameter rods 61 simultaneously move up and down.

Furthermore, the actuator 64 is fixed to an actuator 66 with a fixing tool 65, and the actuator 54 is driven in the horizontal direction (direction shown by the arrow X), as shown in the figure, along a rail 67. As a result, the small-diameter rods 61 move together with the holder 62 at the same time in the horizontal direction, more specifically, the small-diameter rods 61 can reach the space above the tip rack 4. The actuators 64, 66 thus function as a second drive unit.

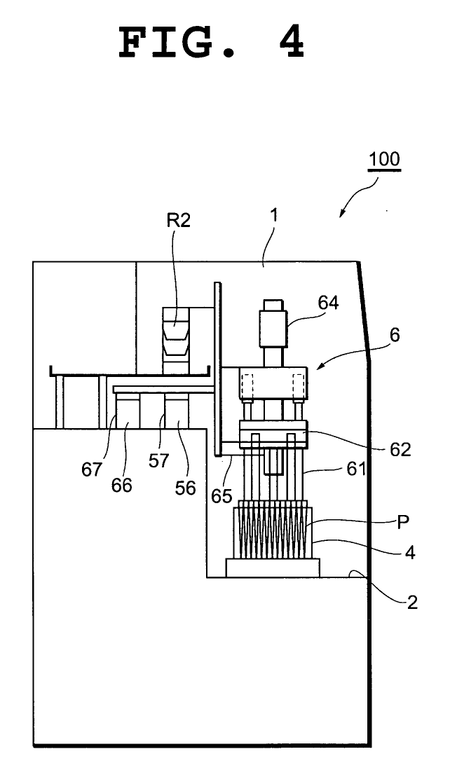

Furthermore, the power source cables of the actuators 54, 64 are accommodated in respective flexible rails R1, R2 (see FIGS. 3, 4) and can be bent together with the flexible rails R1, R2 to follow the movement of the actuators 54, 64.

In the tip filter filling apparatus 100 of the above-described configuration, first, the filter F is set on the base 2 and the required number of tips P are set on the tip rack 4 (first step). Then, the actuator 56 is operated, the filter punching-discharging mechanism 5 is driven, and the small-diameter pipes 51 are stopped in the prescribed original position above the base 2. Then, the actuator 54 is operated and the holder 52 is lowered at the prescribed rate to a position in which the distal tips (lower ends) of small-diameter pipes 51 just abut against the carrying surface of the filter F in the sheet holder 3, and then the holder 52 is raised to a position in which the distal ends of the small-diameter pipes 51 are positioned at a level higher than the upper ends of the tips P accommodated in the tip rack 4.

As a result, parts of the filter F are simultaneously punched with a plurality of small-diameter pipes 51, and the punched parts of the filter F are held in an attached state inside the distal end sections of the small-diameter pipes 51 and are separated from the filter F carried on the base 2 when the small-diameter pipes 51 are raised (second step).

Then, the actuator 56 is operated and the filter punching-discharging mechanism 5 is driven toward the tip rack 4 and stopped in a position in which the distal ends of the small-diameter pipes 51 become coaxial with each tip P in the prescribed row. The actuator 54 is then driven and the distal ends of the small-diameter pipes 51 are inserted into the inner spaces of tips P and stopped in the prescribed positions. Then, the valve H provided in the pipe connected to the nitrogen gas supply unit N is opened and nitrogen gas is supplied into the small-diameter pipes 51 via the cylinder 53. As a result, the filter F held in the distal end section of the small-diameter pipes 51 is blown out downward inside the tips P by the supplied pressure of the nitrogen gas (gas supply step, third step).

The filter F punched with the small-diameter pipes 51 has an outer diameter almost equal to the inner diameter of the small-diameter pipes 51, that is, has an outer diameter equal to or somewhat larger than the inner diameter of the distal end sections of the tips P, and also has an outer diameter equal to or somewhat less than the inner diameter of the upper end section of the tips P. Therefore, it is abutted against the peripheral inner wall of the distal end section of the tip P and stopped. At this time, parts of the filter F are held in a state in which they are loosely fitted into the distal end sections of tips P by the power of gas that blew them out.

The actuator 54 is again operated and the holder 52 is raised till the distal ends of the small-diameter pipes 51 are positioned at a level higher than the distal ends of the tips P accommodated in the tip rack 4. Then, the actuator 56 is again operated and the filter punching-discharging mechanism 5 is driven toward the holder 2 and returned, for example, to the original position where it was located prior to punching the filter F.

The actuator 66 is then operated and the filter push-in mechanism 6 is driven toward the tip rack 4 and stopped in a position in which the distal end of each small-diameter rod 61 is coaxial with a respective tip P in the prescribed row where parts of the filter F are accommodated. The actuator 64 is then operated, the small-diameter rods 61 are inserted into the internal spaces of tips P, and the holder 62 is lowered to a position in which parts of the filter F are pushed by the small-diameter rods 61 from the tips P toward the distal ends and the holder is stopped in this prescribed position (fourth step).

Then, the actuator 64 is again operated and the holder 62 is raised to a position in which the distal ends of the small-diameter rods 61 are at a level higher than the upper ends of the tips P accommodated in the tip rack 4. As a result of those operations, parts of the filter F that were loosely fitted into the distal end sections of the tips P are reliably pushed into the distal end sections of the tips P and strongly attached and fixed therein. A plurality of tip devices Q (8 in the present embodiment) shown in FIG. 5 are thus simultaneously manufactured.

The actuator 66 is then again operated and the filter push-in mechanism 6 is moved to the side opposite that of the holder 2 and returned to the original position. In the present embodiment, the above-described operation is successively and repeatedly executed with respect to the remaining 11 rows of tips P, and the operations of inserting and filling the filter F are implemented with respect to all the tips P accommodated in the tip rack 4. Then, the tip rack 4 is removed from the base 2 and a total of 96 tip devices Q obtained in 8 rows and 12 columns are recovered.

With the tip filter filling apparatus 100 of the above-described configuration and the method for manufacturing the tip devices P that uses this apparatus, the filter F carried on the holder 3 is always punched to the fixed size with the small-diameter pipes 51. Therefore, the amount of the filter F with which the tip device Q is filled is always constant. In particular, because filling the tips P with parts of the filter F is conducted by blowing under pressure nitrogen gas, reproducibility of the operation of filling the tip P with the filter F from the small-diameter pipes 51 can be substantially increased. As a result, quality and reliability of the tip devices Q can be increased.

Furthermore, because the filter F is pushed into the distal end sections of tips P by a constant operation of the small-diameter rods 61, the fixing state of the filter F also can be made uniform. As a result, the spread between the products can be further suppressed and quality and reliability of the tip devices Q can be further increased.

Furthermore, because the operation involves not only punching the filter F, but also using the gas supply to load parts of the filter F that were punched and cut out into the tips P, the manufacture of the tip devices Q can be implemented rapidly and easily. As a result, the dependence on the operator's skills and operation conditions is eliminated, by contrast with the conventional processes in which the filter F is loaded into tips P by manual operations, spread between the products can be further inhibited, the operation efficiency can be increased, and the production time can be shortened. Therefore, the production efficiency and yield of the tip devices Q can be greatly increased. Moreover, because the series of operations leading to strong filling also can be conducted automatically without manual operations, the reliability and production efficiency of the products can be further increase.

Moreover, executing the operations of punching the filter F in a plurality of places at the same time by using a plurality of small-diameter pipes 51, simultaneously loading the punched-out portions into a plurality of tips P accommodated in the tip rack 4, and then pushing and loading the filter F into respective tips P with a plurality of small-diameter rods 61 makes it possible to manufacture simultaneously and continuously a large number of tip devices Q of stable quality.

Moreover, the carrying surface of the filter F in the sheet holder 3 is smooth, and when the small-diameter pipes 51 punch the filter F carried on the sheet holder 3, the distal ends at one end of the small-diameter pipes 51 are lowered to a position that just abuts against this carrying surface and are not inserted deeper. As a result, the filter F is prevented from indenting the carrying surface of the sheet holder 3. For this reason, the filter F can be punched reliably. Therefore, the production efficiency of tip devices, reliability of the devices, and yield can be further increased even when the filter F is in the form of a comparatively thin sheet with a thickness of several millimeters or less.

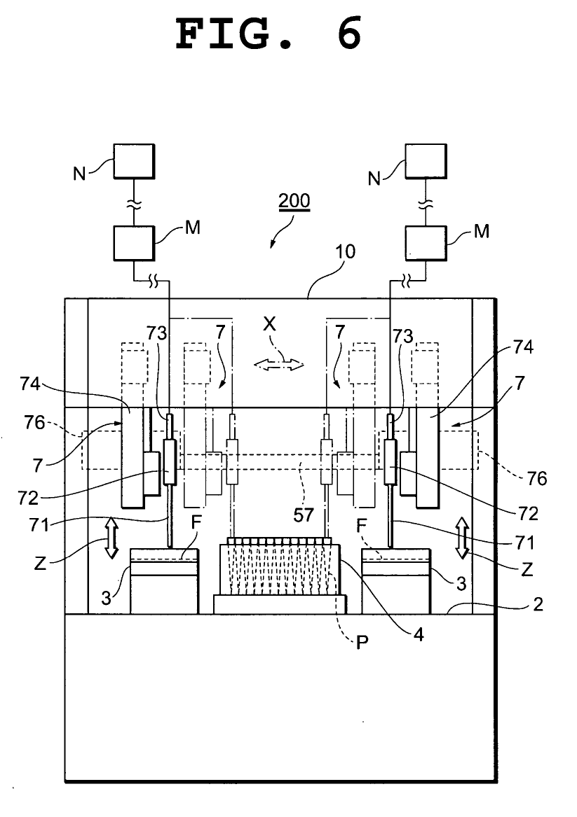

FIG. 6 is a front view illustrating schematically another preferred embodiment of the system for manufacturing a tip device according to the present invention. A tip filter filling apparatus 200 (system for manufacturing a tip device) has a configuration identical to that of the tip filter filling apparatus 100, except it comprises two (two systems) filter punching-discharging mechanisms 7 (sheet punching units) instead of the filter punching-discharging mechanisms 5 and filter push-in mechanism 6, one more sheet holder 3 (sheet holding unit) is provided, and a gas pressure adjustment unit M (pressure adjustment unit) is provided between each filter punching-discharging mechanism 7 and each nitrogen gas supply unit N.

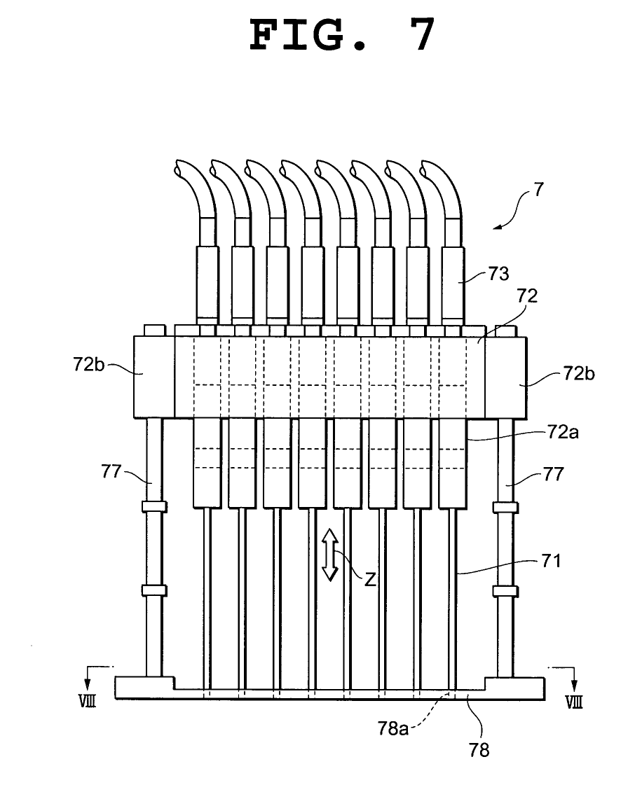

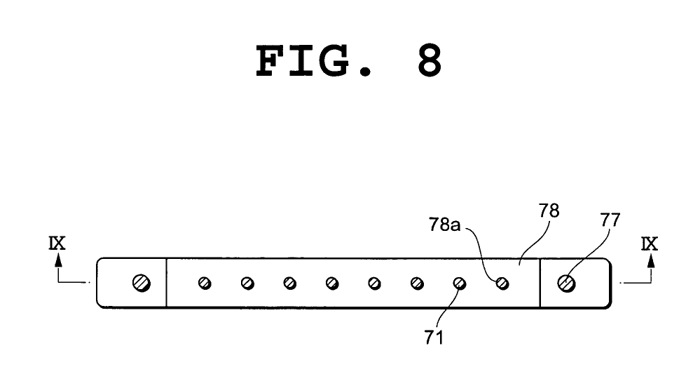

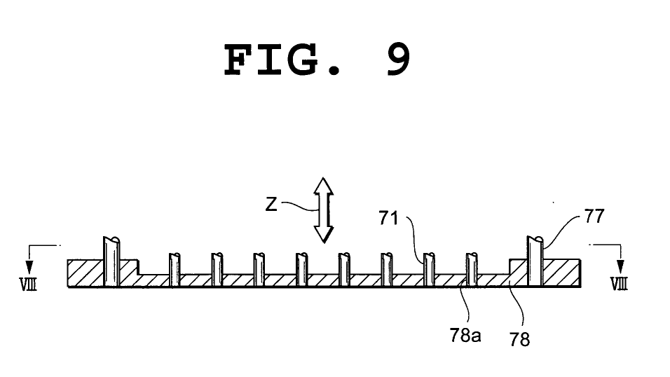

Here, FIG. 7 is a front view illustrating a schematic configuration of the filter punching-discharging mechanism 7, FIG. 8 is a cross-sectional view along the VII-VII line in FIG. 7, and FIG. 9 is a cross-sectional view along the IX-IX line in FIG. 8.

In the filter punching-discharging mechanism 7, a total of eight straight cylindrical small-diameter pipes 71 arranged in a row in the same direction as the row of tips P are detachably fixed to a holder 72. The small-diameter pipes 71 have an inner diameter equal to or somewhat larger than the inner diameter of the distal end section of the tip P and also have an inner diameter equal to or somewhat smaller than the inner diameter of the upper end sections of the tip P. Furthermore, the small-diameter pipes 71 extend in the up-down direction, as shown in the figure, and one end thereof (lower end as shown in the figure) is open.

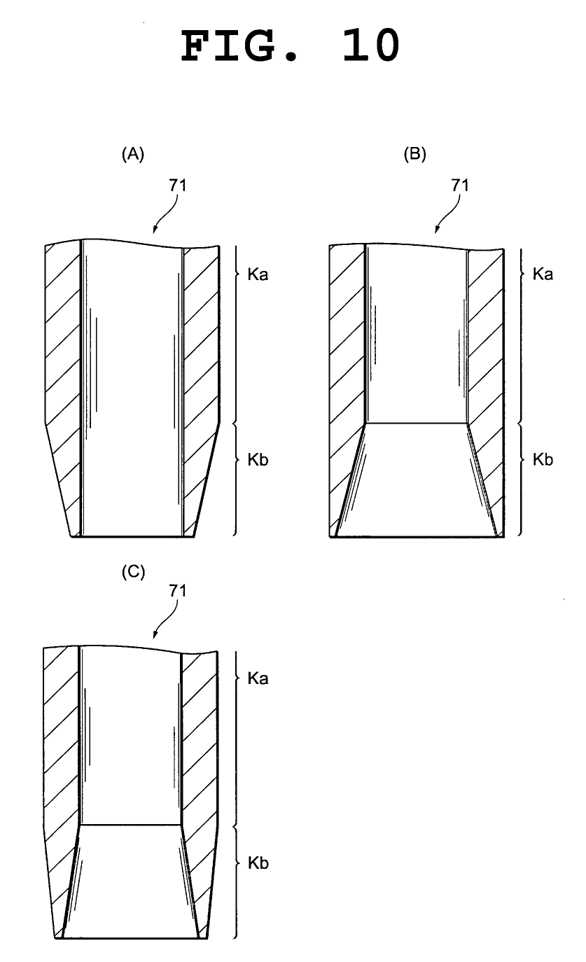

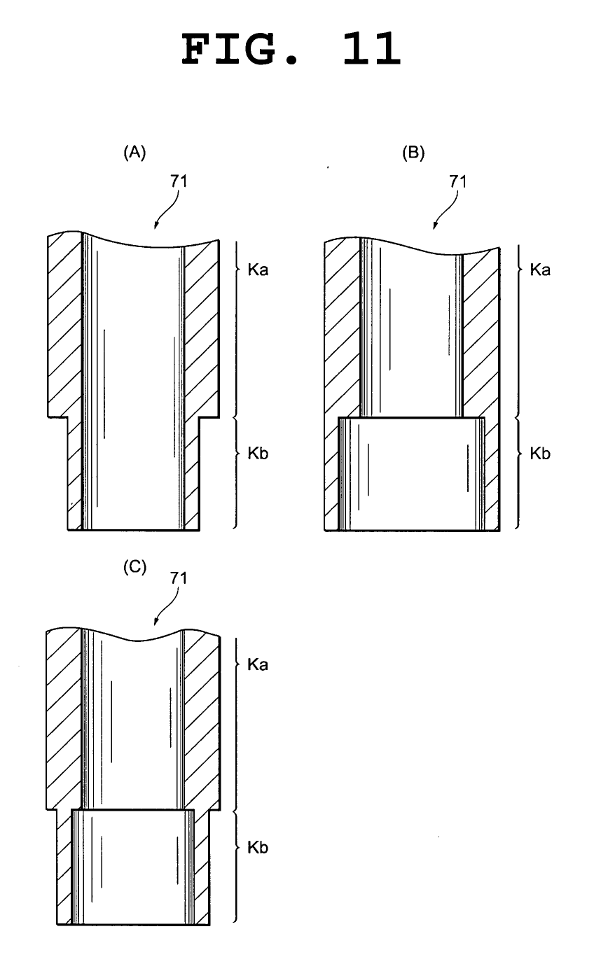

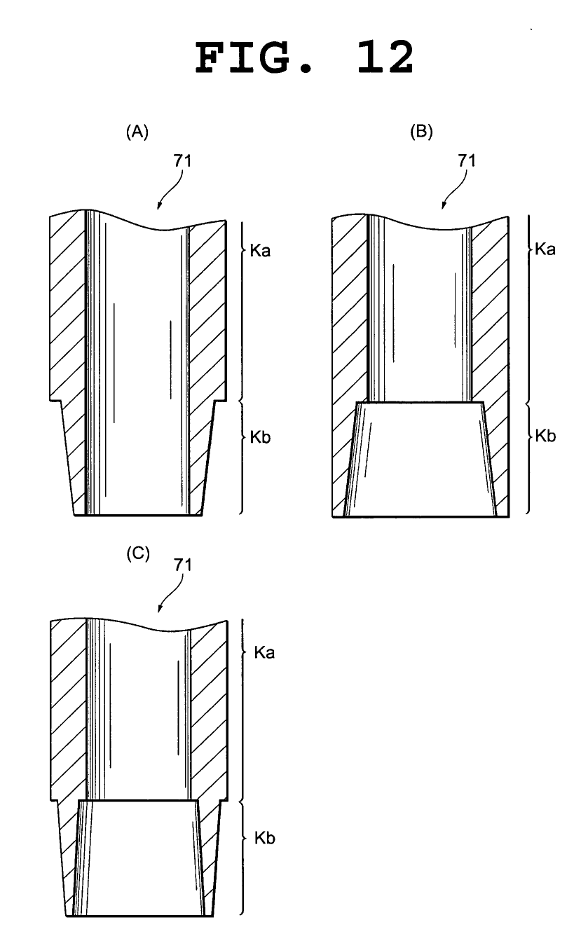

Here, FIGS. 10(A) to (C), FIGS. 11(A) to (C), and FIGS. 12(A) to (C) are schematic cross-sectional views illustrating part of the small-diameter pipe 71. In all the small-diameter pipes 71 shown in the figures, the thickness of the distal end section Kb (one end) is less (the section is thinner) than the thickness of the body section Ka (thickness of the peripheral wall).

More specifically, in the small-diameter pipe 71 shown in FIGS. 10(A) to (C), the peripheral wall of the distal end section Kb is annularly tapered so that the thickness of the peripheral wall decreases gradually from the body section Ka of constant thickness to the distal end section Kb. More specifically, in FIG. 10(A), the outer wall of the distal end section Kb is tapered. Furthermore, in FIG. 10(B), the inner wall of the distal end section Kb is tapered, and in FIG. 10(C), both the inner wall and the outer wall of the distal end section Kb are tapered.

On the other hand, in the small-diameter pipe 71 shown in FIGS. 11(A) to (C), the distal end section Kb having a constant thickness that is less than the thickness of the body section Ka having a constant thickness is provided in an extending conditions from the body section. More specifically, in the configuration shown in FIG. 11(A), the outer wall surfaces of the body section Ka and distal end section Kb mate and a step is provided on the inner wall. Furthermore, in the configuration shown in FIG. 11(B), the inner wall surfaces of the body section Ka and distal end section Kb mate and a step is provided on the outer wall. Moreover, in the configuration shown in FIG. 11(C), steps are provided on both the inner wall and the outer wall surfaces of the body section Ka and distal end section Kb.

On the other hand, in the small-diameter pipes 71 shown in FIGS. 12(A) to (C), a step is provided on the boundary between the body section Ka and distal end section Kb, and the peripheral wall of the distal end section Kb is annularly tapered so that the thickness of the peripheral wall decreases gradually from the body section Ka having a constant thickness to the distal end section Kb. More specifically, in the configuration shown in FIG. 12(A), the outer wall of the distal end section Kb shown in FIG. 11(A) is tapered. In the configuration shown in FIG. 12(B), the inner wall of the distal end section Kb shown in FIG. 11(B) is annularly tapered. In the configuration shown in FIG. 12(C), both the inner wall and the outer wall of the distal end section Kb shown in FIG. 11(C) are annularly tapered.

Furthermore, a cylinder 73 connected to the above-described gas pressure adjustment unit M is linked to the other end of the small-diameter pipe 71. The gas pressure adjustment unit M is designed to adjust the supply pressure of the nitrogen gas supplied from the nitrogen gas supply unit N to the cylinder 73 (for example, a regulator for pressure adjustment can be used for this purpose) and may be provided between the valve H (see FIG. 3) and the cylinder 73 or may be provided between the valve H and the nitrogen gas supply unit N. Thus, in the present embodiment, the gas supply unit comprises the nitrogen gas supply unit N, cylinder 73, gas pressure adjustment unit M, and pipe with the valve H provided therein.

Furthermore, the small-diameter pipe 71 is fixed to the punching block 72a of the holder 72. The holder 72 is connected to an actuator 74 (first drive unit). As a result, the holder 72 can be driven in the up-down direction (direction of arrow Z) as shown in the figure, and all the small-diameter pipes 71 can be moved up and down at the same time. Furthermore, one end section of extendable slide shafts 77, 77 that extend in the same direction as the small-diameter pipe 71 are fixed to both end sections of the holder 72b of the holder 72. An integrated-type guide plate 78 (sheet fixing unit) is disposed at those other end sections (lower end sections shown in the figure). Here, when the slide shaft 77 is contracted, it may be impelled in the extension direction with an elastic body, for example, oil pressure, air pressure, or a spring.

Guide orifices 78a (opening) having a diameter somewhat larger than the inner diameter of the small-diameter pipes 71 are drilled in the guide plate 78 in the positions corresponding to the small-diameter pipes 71. Furthermore, the distal ends of the small-diameter pipes 71 are inserted into those guide orifices 78a. As a result, the guide plate 78 is disposed around the small-diameter pipes 71, so that the small-diameter pipes 71 are guided through the guide orifices 78a.

The actuator 74 is fixed to the actuator 76 (second drive unit) with a fixing tool 55 (see FIG. 2), and the actuator 74 is driven in the horizontal direction (direction of arrow X), as shown in the figure, along the rail 57. As a result, the small-diameter pipes 71 move simultaneously together with the holder 72 in the horizontal direction, more specifically, the small-diameter pipes 71 move reciprocally between the respective spaces above the sheet holder 3 and tip rack 4.

In the tip filter loading device 200 of such a configuration, the two filter punching-discharging mechanisms 7, 7 are continuously operated simultaneously or with a certain delay in time (for example, the filter punching-discharging mechanism 7 shown on the left side in the figure is first operated and then the filter punching-discharging mechanism 7 shown on the right side of the figure is operated), and parts of the filter F are punched out simultaneously or almost simultaneously from both filters F placed on the two sheet holders 3 (second step).

If the holder 72 is driven at this time by the operation of the actuator 74, the guide plate 78 moves down together with the small-diameter pipes 71. Furthermore, if the guide plate 78 abuts against the filter 3, the guide plate 78 is impelled downward, as shown in the figure, by the weight of the filter punching-discharging mechanism 7, and this guide plate 78 is fixed so as to press the filter F to the sheet holder 3. If the holder 72 is further moved down in this state by the actuator 74, the pressure from the actuator 74 is further added to the weight of the filter punching-discharging mechanism 7, the guide plate 78 is further impelled downward, as shown in the figure, and the small-diameter pipe 71 punches part of the filter F, while the filter F is more strongly pushed and tightly fixed.

At this time, if the guide plate 78 is further impelled by the slide shaft 77, as described hereinabove, the filter F is more strongly pushed and even more tightly fixed to the sheet holder 3.

Furthermore, after the small-diameter pipe 71 moved to the prescribed height, the two filter punching-discharging mechanisms 7, 7 are moved simultaneously or with a certain difference in time toward the tip rack 4, and the distal end of the small-diameter pipe 71 is inserted into the inner space of the tip P. Then, a valve H provided in a piping connected to a nitrogen gas supply unit N is opened, and nitrogen gas is supplied at a gas pressure (first pressure) adjusted with the gas pressure adjustment unit M into the small-diameter pipe 71 through he cylinder 73. As a result, the filter F held in the distal end section of the small-diameter pipe 71 is blown out downwardly inside the tip P and attached to the distal end section (gas supply step, third step).

Then, the gas pressure from the nitrogen gas supply unit N is further increased (second pressure) with the gas pressure adjustment unit M and the nitrogen gas is again supplied into the small-diameter pipe 71 through the cylinder 73. As a result, the filter F attached to the distal end section of the tip P is further pushed into the distal end side of the tip P and strongly held and fixed thereto. As a result, a plurality (16 in the present embodiment) of tip devices Q shown in FIG. 5 can be manufactured simultaneously or almost simultaneously.

Thus, with the tip filter filling apparatus 200, providing two filter punching-discharging mechanisms, 7, 7 makes it possible to increase the production efficiency of tip devices P (production time is shortened). Furthermore, if the two filter punching-discharging mechanisms 7, 7 are operated with a certain difference in time, in the case of a single tip rack 4, the interference of the filter punching-discharging mechanisms 7, 7 located above the rack can be prevented.

Furthermore, because the gas pressure adjustment unit M is provided, the pressure of the nitrogen gas at the time the filter F is discharged from the small-diameter pipe 71 can be adjusted randomly or as desired, for example, according to the properties of the filter F or the internal shape of the tip P. As a result, the apparatus can be adapted for the manufacture of various tip devices Q using a variety of filters F and tips P. Furthermore, increasing the supply pressure of the nitrogen gas makes it possible to attach part of the filter F discharged into the tip P more reliably to the distal end section of the tip P and to fix it more strongly. Therefore, the filter push-in mechanism 6 may be omitted. As a result, restrictions placed on the arrangement of the two filter punching-discharging mechanisms 7, 7 can be relaxed and the design margin can be increased, while simplifying the apparatus scale.

Furthermore, because the thickness of the distal end section Kb which is at one end of the small-diameter pipe 71 is set less than the thickness of the body section Ka, the pressure acting when the distal end of the distal end section Kb applies pressure to the filter F is increased and the filter F can be cut easier. In this case, if a shape is employed in which the thickness of the distal end section Kb decreases gradually toward the distal end thereof (for example, see FIG. 10(A) to (C) and FIG. 12(A) to (C)), the distal end thereof becomes sharper and cutting capability of the filter F is further improved. As a result, the filter F can be punched easier, the outer peripheral shape of part of the punched-out filter F is made smoother and dimensional accuracy is greatly increased.

Furthermore, because the filter F is pushed against (pushed in) the sheet holder 3 by the guide plate 78 when the filter F is punched with the distal end of the small-diameter pipe 71, the filter F is fixed with good stability, thereby preventing the filter F from being displaced. As a result, inconveniences caused by the displacement of filter F, such as incomplete punching of the filter F or degradation of dimensional accuracy of the punched filter F, can be prevented and the production yield of the tip devices Q can be increased.

In particular, because the guide plate 78 is in the form of a sheet, a plurality of guide orifices 78a are provided in a row in positions corresponding to a plurality of pipes 71 that are orderly arranged, and the guide-diameter pipes 71 are guided by those guide orifices 78a, the circumferences of parts of the filter F that will be punched with the pipes 71 are continuously covered and fixed with the guide plate 78. As a result, the filter F can be prevented from shifting even more reliably. In particular, reliable punching can be implemented even when the filter F is in the form of a comparatively thin sheet with a thickness of several millimeters or less.

Moreover, if the carrying surface for the filter F in the sheet holder 3 is smooth, one distal end of the small-diameter pipe 71 is lowered to a position in which it exactly abuts against the carrying surface and is not inserted deeper, similarly to the small-diameter pipe 51 of the tip filter filling apparatus 100, the filter F can be prevented from indenting the carrying surface of the sheet holder 3. For this reason, and also because the filter F is fixed, the filter F can be punched more reliably and the production efficiency of tip devices, reliability of the devices, and yield can be further increased even when the filter F is in the form of a comparatively thin sheet with a thickness of several millimeters or less.

Furthermore, in the present embodiment the surface area of the guide plate 78 was set much larger than the surface area of the guide orifices 78a. Therefore, a very wide range around part of the filter F that will be punched by the pipe 71 is pushed by the guide plate 78. As a result, the force fixing the filter F is further increased.

Furthermore, because the distal end section of the small-diameter pipe 71 is inserted into the guide orifice 78a provided in the guide plate 78, the small-diameter pipe 71 is prevented from moving in the horizontal direction. As a result, the displacement of the small-diameter pipe 71 during punching of the filter F can be inhibited and, therefore, the filter F can be punched more reliably.

The present invention is not limited to the above-described embodiment and can be changed in a variety of ways, without departing from the essence thereof. For example, the small-diameter pipes 51, 71, tips P, and small-diameter rods 61 are not limited to the above-described numbers, and each such component may be used individually or a plurality thereof may be used. For example, when a single small-diameter pipe 51, 71 is used, punching and filling operations of the filter F may be conducted successively and repeatedly with respect to a plurality of tips P. In addition, the distal end section of the small-diameter pipe 51 may be formed to have a thickness less than that of the body section and so that the thickness thereof decreases gradually toward the distal end, similarly to the small-diameter pipe 71. Alternatively, the entire small-diameter pipe 51, 71 may have a fixed thickness, but the distal end section thereof may be thinner than the body section.

Furthermore, a plurality of filters F may be laminated inside the tip P. In this case, a plurality of filters F may be together carried by the sheet holder 3, punched with small-diameter pipes 51, 71 at the same time, and loaded into the tip P, or the punching-discharging operations may be repeatedly executed with respect to one filter F. Moreover, filters F of a plurality of different kinds may be laminated and loaded into the same tip P. In this case, a gas pressure adjustment unit M is preferably provided, as a tip filter loading unit 200, corresponding to the filter of each kind.

Furthermore, it is not necessary that identical filters F be loaded in all the tips P accommodated in the tip rack 4. For example, if the filter F is replaced with another filter each time the filter F is punched with the small-diameter pipe 51, 71, tip devices Q that differ for each row of the tip rack 4 can be obtained. Moreover, sheet holders 3 and/or tip racks 4 of different size or shape may be arranged on the base 2. In this case, racks for tips of various kinds can be arranged. Thus, the system and method for manufacturing a tip device according to the present invention have excellent utility. Furthermore, the small-diameter pipes 51, 71 and/or holders 52, 72 having small-diameter pipes 51, 71 fixed thereto may be arranged in a plurality of rows. Moreover, other gases for example, air or a rare gas may be used instead of the aforementioned nitrogen gas.

Furthermore, it is not necessary that the filter push-in mechanism 6 be used. In this case, it is preferred that the ejection of the nitrogen gas be continued after part of the filter F has been discharged into the tip P and that the filter F be more strongly loaded into the distal end section of the tip P by the gas pressure. In this case, it is preferred that the gas pressure adjustment unit M such as the tip filter loading apparatus 200 be provided. Conversely, the filter push-in mechanism 6 may be provided in the tip filter loading apparatus 200.

As described hereinabove the system and method for manufacturing a tip device according to the present invention can manufacture the tip device in a simple manner and within a short time. Moreover, because the operation of loading the pretreatment member into the tip has high reproducibility, the quality, reliability, and yield of the product can be increased. As a result, the system and method according to the present invention can be widely used for preparation, such as pretreatment, e.g., of samples comprising biomolecules.

1. A system for manufacturing a tip device for pretreating a solution or a liquid sample, said system comprising a gas supply section for supplying a gas into the tip via a pipe having a substantially tubular shape, so that a pretreatment member held inside said pipe is discharged to the outside of said pipe.

2. The system for manufacturing a tip device according to claim 1, comprising:
a sheet holding section where a sheet member including said pretreatment member is placed;
a tip holding unit which holds said tip;
a sheet punching unit comprising said pipe, and a first drive unit that drives said pipe so that one end of said pipe punches part of said sheet member and so that said pipe that holds part of the punched sheet member is inserted into said tip, wherein
said gas supply section is connected to the other end of said pipe and supplies a gas into said tip so that part of said sheet member held inside said pipe is discharged to the outside of said pipe.

3. The system for manufacturing a tip device according to claim 2, comprising a sheet push-in unit that has a rod having a substantially tubular or substantially columnar shape and a second drive unit which drives said rod so that said rod is inserted into said tip and so that said rod pushes the part of said sheet member that is discharged into said tip.

4. The system for manufacturing a tip device according to claim 2, wherein
in said tip holding unit, a plurality of said tips is arranged side by side.

5. The system for manufacturing a tip device according to claim 2, wherein
said sheet punching unit comprises a plurality of said pipes.

6. The system for manufacturing a tip device according to claim 3, wherein
said sheet push-in unit comprises a plurality of said rods.

7. The system for manufacturing a tip device according to claim 1, wherein
said pretreatment member is an adsorption member that adsorbs a target component contained in said solvent or liquid sample.

8. The system for manufacturing a tip device according to claim 2, comprising a plurality of said sheet punching units.

9. The system for manufacturing a tip device according to claim 2, wherein
said sheet punching unit comprises a sheet fixing section provided so that said sheet member is fixed when part of said sheet member is punched by one end of said pipe.

10. The system for manufacturing a tip device according to claim 9, wherein said sheet fixing unit fixes the circumference of said pipe in said sheet member when one end of said pipe abuts against said sheet member.

11. The system for manufacturing a tip device according to claim 9, wherein
said sheet fixing unit is shaped as a plate, has an opening for inserting said pipe, is provided around said pipe so that said pipe is guided by passing through said opening, and is impelled toward one side of said pipe along the drive direction of said pipe in a state of abutting against said sheet member.

12. The system for manufacturing a tip device according to claim 1, wherein
said gas supply unit comprises a pressure adjustment unit connected to the other end of said pipe and serving to adjust the pressure of said gas.

13. The system for manufacturing a tip device according to claim 1, wherein
the thickness of one end of said pipe is less than the thickness of the body section of said pipe.

14. The system for manufacturing a tip device according to claim 1, wherein
the thickness of said pipe decreases gradually toward one end of said pipe.

15. The system for manufacturing a tip device according to claim 1, wherein
said sheet holding unit has a smooth surface where said sheet member is placed.

16. The system for manufacturing a tip device according to claim 15, wherein
said sheet punching unit is so provided that part of said sheet member is punched by moving one end of said pipe to a position in which the one end of said pipe abuts against said smooth surface of said sheet holding unit.

17. A method for manufacturing a tip device for pretreating a solution or a liquid sample, said method comprising a gas supply step of supplying a gas into said tip via a pipe that has a substantially tubular shape and holds a pretreatment member inside thereof, and discharging said pretreatment member into said tip.

18. The method for manufacturing a tip device according to claim 17, comprising:
a first step of preparing a sheet member including said pretreatment member and a tip; and
a second step of punching part of said sheet member with one end of a pipe having a substantially tubular shape, and separating the punched-out part of said sheet member from said sheet member, while holding the punched-out part on one end side of said pipe, wherein in said gas supply step, a third step of inserting one end of said pipe that holds the part of said sheet member into said tip, supplying gas into said pipe from the other end of said pipe, and discharging part of said sheet member into said tip is implemented.

19. The method for manufacturing a tip device according to claim 18, comprising a fourth step of inserting a rod having a substantially tubular or substantially columnar shape into said tip and pushing with said rod the part of said sheet member that was discharged into said tip.

20. The method for manufacturing a tip device according to claim 17, wherein
an adsorption member that adsorbs a target component contained in said solvent or liquid sample is used as said pretreatment member.

21. The method for manufacturing a tip device according to claim 18, wherein
in said second step, said sheet member is fixed when part of said sheet member is punched by one end of said pipe.

22. The method for manufacturing a tip device according to claim 18, wherein
in said second step, the circumference of said pipe in said sheet member is fixed when one end of said pipe abuts against said sheet member.

23. The method for manufacturing a tip device according to claim 17, wherein
in said second step, by using a sheet holding unit having a smooth surface where said sheet member is placed, part of said sheet member is punched by moving one end of said pipe to a position in which the one end of said pipe abuts against said smooth surface of said sheet holding unit.
